(19) United States
(12) Patent Application Publication
(10) Pub. No.: US 2023/0029380 A1
(43) Pub. Date: Jan. 26, 2023

(54) SYSTEM AND METHOD OF MULTILATERAL COMPUTER RESOURCE REALLOCATION AND ASSET TRANSACTION MIGRATION AND MANAGEMENT

(71) Applicant: UNIFABRIX LTD, HAIFA (IL)

(72) Inventors: Ronen Aharon Hyatt, Haifa (IL); Danny Volkind, Nesher (IL)

(73) Assignee: UNIFABRIX LTD, HAIFA (IL)

(21) Appl. No.: 17/857,248

(22) Filed: Jul. 5, 2022

Related U.S. Application Data
(60) Provisional application No. 63/218,511, filed on Jul. 6, 2021.

(51) Int. Cl. G06F 9/50; G06F 16/23; G06F 9/48

(52) U.S. Cl. CPC G06F 9/505; G06F 16/2379; G06F 9/4856

(57) ABSTRACT

A computer based system and method for multilateral computing resource reallocation and asset transaction migration may include: receiving a resource transaction request; determining a policy for the request; identifying, in a resource monitoring database, resources to service the request and choosing resources matching the policy determined for the request; and documenting the choosing of resources in the monitoring database. Embodiments may further include automatically reallocating occupied resources to alternative transactions and/or migrating currently-running tasks to idle resources, for example according to predefined conditions. Embodiments of the invention may allow performing various dynamic, granular computational resource and/or asset reallocation and/or transaction migration procedures which may involve dynamic composition granular individual resources and/or assets (e.g. of multiple types and/or sizes) into functional resources (to be used by, e.g., various workload execution instances) by a resource reallocation hub, which may further include various dedicated modules and/or engines and/or components.

### FIELD OF THE INVENTION

The present invention relates to infrastructure as a service, data center, compute and data storage facilities. More particularly, the present invention relates to systems and methods for multilateral computer resource reallocation and computational asset transaction migration and management.

### BACKGROUND

Contemporary datacenters are made of multiple types of assets or computer resources, whether they are physical assets, logical assets or virtual assets. These data assets may include complete systems and platforms such as servers, appliances, networking gear, storage devices or virtual servers. Other types of assets may include hardware-level components, such as GP-CPUs (general purpose compute cores), memory components and storage components of different media types (e.g., persistent memory DIMMs (dual in-line memory modules)), GPUs (graphics processing units), accelerators and alike.

Assets may be identified automatically, such as via hardware discovery (e.g., PCIe (Peripheral Component Interconnect Express) enumeration), BIOS (basic input/output system) scanning (e.g., ACPI (Advanced Configuration and Power Interface)), firmware, software (e.g., by the OS (Operating System)) reading asset inventory lists or probing for assets, external management layers dictating the list of assets and their physical/logical topology (e.g., NUMA (non-uniform memory access)), or similar methods.

Datacenter assets or computer resources are usually interconnected by multiple types of physical, logical, and virtual interfaces, fabrics and networks. For example, physical assets such as NVMe (non-volatile memory express) storage devices may be connected to a GP-CPU physical asset over a PCIe physical interface. Additional physical assets such as memory DRAM (dynamic random access memory) DIMMs may be connected to the GP-CPU physical asset over a JEDEC DDR5 channel physical interface. Similarly, a physical asset such as an SR-IOV (single root I/O virtualization) Ethernet NIC (network interface controller) may be connected to a VM (virtual machine) over a virtual PCIe interface.

Asset instances residing locally within a particular platform (e.g., within a server, SoC (system on a chip), etc.), are usually exposed to local hardware and/or software elements as functional resources that serve as basic function-specific means such as compute, memory, storage, network, etc. Such functional assets or resources are available for consumption by local workload execution instances (e.g., OS, VMs, containers, storage backend software running on a SmartNIC, DMA/RDMA (remote direct memory access) engine, etc.).

For example, a physical asset instance or resource such as a GP-CPU placed within a server socket, provides compute functional resources in the form of vCPUs to a workload execution instance in the form of a VM. In another example, a physical asset or asset instance in the form of multiple DRAM DIMM memory modules attached to a GP-CPU, provide memory functional resources to a workload execution instance in the form of an OS running on that platform.

Oftentimes in datacenters, the utilization levels of assets or resources (and hence the derived utilization level of the functional resources composed and exposed from these assets) is relatively low, leading to excessive waste of CAPEX (capital expenditures) and OPEX (operating expenses), and therefore resulting in high costs such as of TCO (total cost of ownership).

Low utilization levels may be attributed, in part, to stranding effects, such as assets and functional resources that exist in one location of the datacenter but cannot be provisioned or consumed along with other assets and functional resources in other locations of the datacenter. Considerable work has been done in the past on resource disaggregation, and, by taking a different approach, on resource pooling. Both approaches target, among other things, the improvement of asset and resource utilization in the datacenter, however with limited success, mainly due to technological and architectural obstacles that were not yet completely resolved. Other factors contributing to low utilization levels stem from the methods and flows used to allocate functional resources to e.g. workload execution instances such as VMs (Virtual Machines) and containers (a sort of lightweight VMs).

Thus, functional resources may be statically pre-allocated to such instances, regardless of their actual dynamic consumption of these functional resources. In such scenarios, for example, a VM instance is initiated with a certain amount of compute functional resources (e.g., four vCPU cores) and memory functional resources (e.g., 4 GB of actual physical memory). In many cases, the vCPU cores are directly translated to allocation of physical CPU cores, such as via the common ratio of one physical CPU core for two VCPUs (e.g., hyper-threaded).

Thus, in periods of time where for example the VM does not use or consume the entire amount of functional resources allocated to it, these functional resources remain idle while they could have been used by other VMs that require more functional resources for achieving a more effective execution.

Data center operators usually seek to increase the utilization levels of assets, for example in order to monetize the expensive investment in these resources and/or assets and yield an effective workload production for datacenter users. Within a modern data center execution environment, CSPs (Cloud Service Providers) usually charge users based on for example the type of workload execution instance (e.g., a VM and the resources and/or assets used to execute it), its capacities and specs, and a specific resource reallocation model may for example lease physical and virtual workload execution instances of different types and capacities, such as VMs, containers, and bare-metal server instances.

Therefore, it can be desirable to offer a system and method for multilateral computer resource reallocation and asset transaction migration in order to, for example, allow near-optimal utilization of computation resources and/or assets in such data centers and/or high-performance computing platforms.

### SUMMARY

A computer based system and method for multilateral computing resource reallocation and asset transaction migration and management may include: receiving a resource transaction request which may include one or more computational tasks; determining a policy for the request; identifying, in a resource monitoring database (which may include a plurality of computing resources and policies describing the resources), resources to service the request; choosing one or more of the identified resources which may correspond to the policy determined for the request; and documenting the choosing of the resources in the monitoring database. Embodiments may further include monitoring or tracking the resource monitoring database to identify idle resources; choosing currently available resources, for example according to predefined conditions; monitoring a resource transaction database, which may include a plurality of resource transactions, and choosing transactions, for example according to predefined conditions; and either reallocating the idle resources to service the transactions—or migrating one or more tasks included in the transactions to the idle resources—for example according to predefined conditions.

Embodiments of the invention may allow performing various dynamic, granular computational resource and/or asset reallocation and/or transaction migration procedures which may include discovery, and/or identification, and/or monitoring, and/or harvesting, and/or extraction, and/or classification, and/or policy determination, and/or grading, and/or exposing, and/or transacting, and/or dynamic composition of granular individual resources and/or assets (e.g. of multiple types and/or sizes) into functional resources (to be used by, e.g., various workload execution instances) by a resource reallocation hub, which may further include various dedicated modules and/or engines and/or components.

In some embodiments of the invention, resource reallocation and/or transaction migration and/or management procedures may involve or use a plurality of data structures and/or datasets—such as a resource and/or asset monitoring database, and a resource and/or asset transaction database which may for example be stored in and/or updated by the resource reallocation hub.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of a computing device, according to some embodiments of the invention;

FIG. 2 shows a block diagram of an example platform having physical computing resources, according to some embodiments of the invention;

FIG. 3 shows a block diagram of example local computing resources on the platform of FIG. 2, according to some embodiments of the invention;

FIG. 4 shows a block diagram of a resource reallocation hub, according to some embodiments of the invention;

FIG. 5A shows a block diagram of the resource reallocation hub within a platform, according to some embodiments of the invention;

FIG. 5B shows a continuation of the block diagram of FIG. 5A, according to some embodiments of the invention;

FIG. 6 shows block diagram of component level of the resource reallocation hub within the platform, according to some embodiments of the invention;

FIG. 7A shows a block diagram of the resource reallocation hub in various resource pooling topologies, according to some embodiments of the invention;

FIG. 7B shows a continuation of the block diagram of FIG. 7A, according to some embodiments of the invention;

FIG. 8 shows a block diagram of resource reallocation hubs that are interconnected via fabric, according to some embodiments of the invention;

FIG. 9 shows a block diagram of a resource reallocation hub with indirect communication, according to some embodiments of the invention;

FIG. 10 shows a block diagram of a tiered resource policy database, according to some embodiments of the invention;

FIG. 11 shows a platform level view of a resource inventory graph, according to some embodiments of the invention;

FIG. 12 shows a rack level view of a resource inventory graph, according to some embodiments of the invention;

FIG. 13 shows a cluster level view of a resource inventory graph, according to some embodiments of the invention.

FIG. 14 shows a block diagram of a resource extraction engine for transactions, according to some embodiments of the invention.

FIG. 15 shows a flowchart of a simple method of multilateral computer resource reallocation, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

The terms “module” and “engine” may refer to software, firmware, hardware, and any combination thereof for performing the associated functions described herein. Additionally, while the various modules are described as discrete modules, two or more modules may be combined to form a single module that performs the associated functions according to embodiments of the invention.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof may occur or be performed simultaneously, at the same point in time, or concurrently.

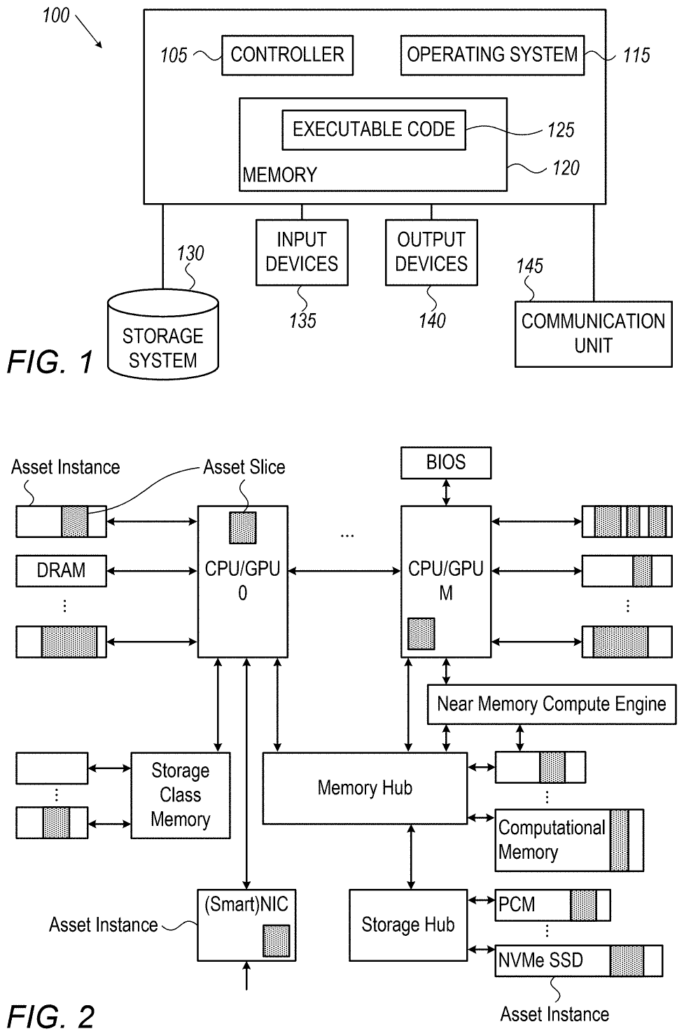

Reference is made to FIG. 1, which is a block diagram of an example computing device which may be used as part of some embodiments of the invention. Computing device 100 may include a controller or processor 105 (e.g., a central processing unit processor (CPU), a chip or any suitable computing or computational device, or a plurality of CPUs and/or suitable such devices), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, a NIC (Network Interface Card) or the like) for communicating with remote devices via a communication network, such as, for example, an Ethernet based network.

Controller 105 may be configured to execute program code to perform operations described herein. The system described herein may include one or more computing device(s) 100.

Operating system (OS) 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate. The terms “OS”, “Hypervisor”, “VMM” (virtual machine monitor/manager), and “Orchestrator” may be used interchangeably, as they all represent entities that govern, control and/or allocate resources on the system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long term memory unit, or other suitable memory units or storage units. Memory 120 may be or may include a plurality of similar and/or different memory units. Memory 120 may be a computer or processor non-transitory readable medium, or a computer non-transitory storage medium, e.g., a RAM.

The terms “storage” and “memory” may be used interchangeably and refer to any type of element(s) that can receive, keep, process and retrieve data of any kind, regardless of form-factor, whether for short-term or long-term retention of the data, whether volatile or non-volatile, whether the element is discrete, combined, hybrid, or embedded into components that perform other functions. For example, “SRAM” (static RAM), “DRAM” (dynamic RAM), “eDRAM” (e.g., memory embedded into CPUs and GPUs), “mass storage”, “SCM” (storage class memory), “Memory Class Storage”, “PMEM” (persistent memory), “Flash”, “Near Memory”, “Far Memory”, “Remote Memory”, “HBM” (High-Bandwidth Memory), “SSD” (Solid State Disk), etc.

Executable code 125 may be any executable code, e.g., an application, a program, a process, computational task or script (note that the term “task” may be used interchangeably with “computational task” throughout the present document to denote for example any part or segment of executable code, and more broadly any set or sequence of operations performed or executed by a computer such as system 100). Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein.

The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. The terms “processor”, “CPU”, “GPU”, and “SoC” may be used interchangeably, as they all represent entities that process data and execute instructions.

In some embodiments, a system may include or may be, for example, a personal computer, a desktop computer, a laptop computer, a workstation, a server computer, a network device, or any other suitable computing device. For example, a system as described herein may include one or more facility computing device and one or more remote server computers in active communication with one or more facility computing device such as computing device 100, and in active communication with one or more portable or mobile devices such as smartphones, tablets and the like.

While terms such as for example “resource(s)”, “asset(s)”, “functional resource(s)”, “functional asset(s)”, and “resource/asset instance(s)” may be known in the art to have slightly technically-different meanings—they may sometimes be used interchangeably in the context of the present description. Those skilled in the art may recognize, however, that different embodiments of the invention may equally be applied and used to manage and/or perform the plurality of procedures and/or operations considered herein on a variety of such different entities and/or combinations of such. The various components and modules described herein may be executed by or may be a computing system such as shown in FIG. 1.

Similarly, terms such as resource and/or asset “reallocation” may, in some cases, be used interchangeably or synonymously with resource and/or asset “allocation” throughout the present document, and correspond to the choosing or the assigning of any type of asset or resource, or a plurality of such, which may be for example available, partly available, occupied, or partly occupied, for performing or executing a computational task (which for example be requested via a resource and/or asset transaction request)—as part of a procedure which involve the migration of resource and/or asset transactions (such as for example described in Procedures I-II described herein). Those skilled in the art may recognize that, in the context of the present document, the term “reallocation” may generally correspond to a set or sequence of allocation and/or deallocation steps which may result in changing or altering the choice of resources and/or assets in the context of performing a given computational task.

Reference is made to FIG. 2, which is a block diagram of an example computing platform having physical computing resources, according to some embodiments of the invention. The platform may include a server, and/or a SoC (system on a chip), and/or a platform on a chip. For example, in case of a SoC, the CPU/GPU may represent embedded processing cores. The available physical computing resources may include DRAM, NVMe SSD, PCM (phase-change memory), SmartNIC, and the like.

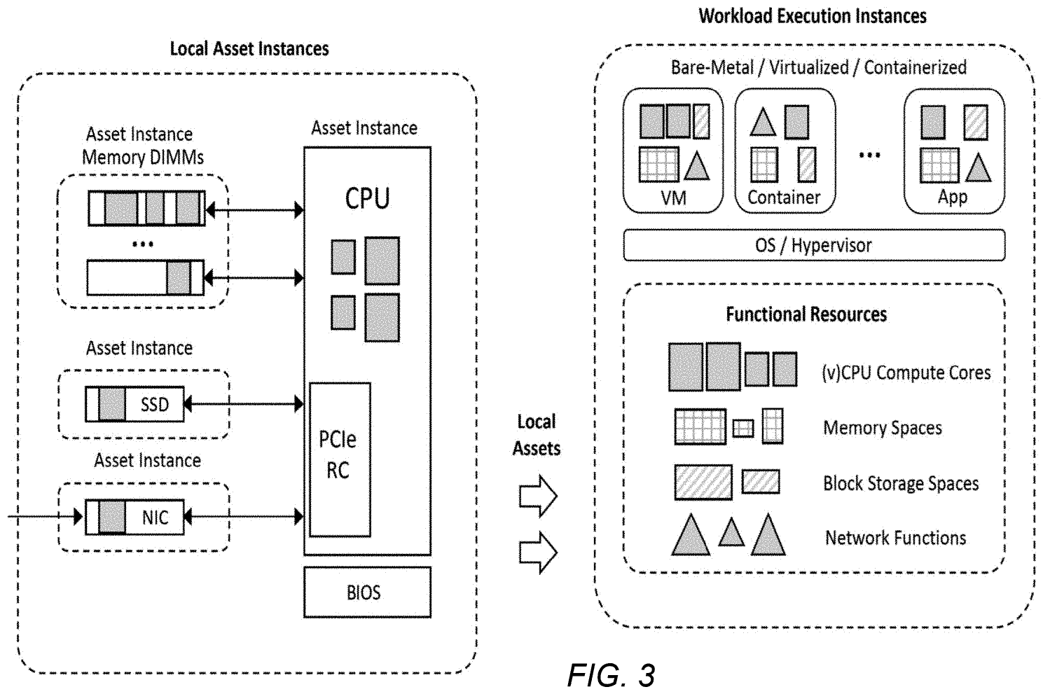

Reference is made to FIG. 3, which is a block diagram of example local computing resources on the platform of FIG. 2, according to some embodiments of the invention. Local computing resources may be for example physically collocated in the same box with some embodiments of the invention (which may constitute for example a resource reallocation hub as further discussed herein). The local computing resources may include memory DIMMs, NICs, hardware drives such as SSD, and CPUs. The local computing resources may be used for e.g. workload execution instances including VMs, containers and applications which may utilize a plurality of functional resources and/or assets for example to service resource and/or asset transaction and/or transaction requests or a plurality of transactions and/or requests as further discussed herein.

According to some embodiments, methods and systems are provided for discovery, and/or identification, and/or monitoring, and/or harvesting, and/or extraction, and/or classification, and/or policy determination, and/or grading, and/or exposing, and/or transacting, and/or dynamic composition and decomposition of granular individual resources and/or assets (of multiple types) into functional resources of multiple types according to, e.g., a resource and/or asset transaction request. For example, granular resources may refer to resources and/or assets of the smallest type (e.g., a single memory cell or block, described by a corresponding memory address), while non-granular resources may refer to complex resources (e.g., including smaller building blocks such as for example a memory chip, or a set of memory cells or blocks composed into a single resource which may be described by a single address or entry in e.g. a resources and/or assets monitoring database as further described herein).

The functional resources and/or assets may be provisioned and/or allocated to workload execution instances regardless of their physical placement and/or association (e.g., both local and remote). Such systems and/or methods for granular resource reallocation and/or management, and or resource and/or asset transaction migration and/or management may be implemented as hardware and/or firmware and/or software. In the context of the present disclosure, “resource (or asset) reallocation” and “resource (or asset) transaction migration” may be considered as synonymous—as the migration of a given transaction by embodiments of the invention may clearly entail a plurality of corresponding reallocation procedures, and vice versa.

According to some embodiments, multilateral computer resources may be reallocated, for example in order to more efficiently utilize resources and/or assets in a data center and/or better service resource and/or asset transactions, or requests for such transactions. Similarly, resource and/or asset transactions may be migrated from for example a first set of resources and/or assets onto a second set of resources and/or assets in order to achieve the latter goals.

Initially, a resource and/or asset transaction request may be received (for example via a data network; see also discussion regarding request contents herein); embodiments of the invention may then determine a policy and/or grading for or to be applied to the request; subsequently, granular computing resources may be identified for allocation or reallocation, for example in order to service the request. At least one resource transaction may then be generated, where the at least one resource transaction is based on a resource and/or asset reallocation policy, and where the at least one resource transaction is configured to reallocate resources between different execution instances.

Finally, the identified computing resources and/or assets may be reallocated to at least one execution instance based on destination information from the generated at least one resource transaction.

In some embodiments, the identified computing resources and/or assets may be classified and/or graded, and a policy for resources and/or assets may be determined, based on properties of the execution instances.

In some embodiments, the computing resources and/or assets of different types for reallocation may be identified, wherein the at least one resource and/or asset transaction is based on type of the identified computing resources.

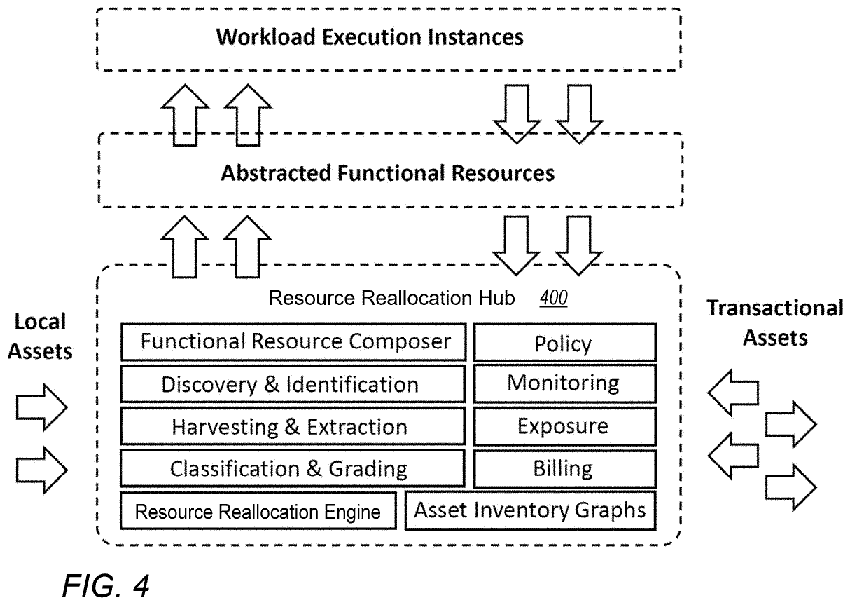

In some embodiments, methods and systems are provided for granular classification and/or grading of assets or resources and derived functional resources, based on for example the merit to specific workload execution instance or set of such instances in order to for example service a resource and/or asset transaction or a request for such transaction in a satisfactory manner. In some embodiments, granular resource reallocation may be for example carried out based on matching demand and supply of assets and functional resources via dedicated hubs operating in multiple tiers (e.g., a resource reallocation hub, as shown in FIG. 4).

In some embodiments, methods and systems are provided for performing multilateral asset or resource transactions, where transactions are carried out with complete resource and/or asset instances or with sets of partial granular asset “slices” (of multiple different types). In other words, embodiments of the invention may decompose complex resources and/or assets into smaller building blocks—as well as compose various functional resources from such smaller building blocks (such as for example granular resources of different types and located in different locations)—in order to for example dynamically allocate resources to a plurality of resource transactions and computational tasks included in such transactions. During the course of these asset and/or resource transactions, the functional resources derived from the assets involved may be recomposed.

In some embodiments, the at least one resource transaction may be generated by a first hub, while exchanging resources with a second dedicated hub. The dedicated hub may be a hub dedicated only for operation of resource reallocation and/or management.

Reference is made to FIG. 4, which is a block diagram of a resource reallocation hub 400, according to some embodiments of the invention. In FIG. 4, hardware elements are indicated with a solid line and the direction of arrows indicate a direction of information flow between the hardware elements.

A resource reallocation hub 400 in some embodiments may include a reallocation and/or migration hub policy engine, for instance to manage reallocation/migration, resource/asset, and transaction/request policies (in this context, see also further discussion regarding policies herein).

A resource reallocation hub 400 in some embodiments may include a resource discovery and identification engine, and/or a resource monitoring engine, such that the resource reallocation hub 400 may for example search and provide discovery and/or identification, and/or monitoring of computer resources.

A resource reallocation hub 400 in some embodiments may include a resource harvesting and extraction engine, such that the resource reallocation hub 400 may provide for example allocating and/or provisioning and/or harvesting and/or extraction of computer resources for reallocation. In the context of the present disclosure, terms such as “allocating”, “provisioning”, “harvesting”, and “extraction” may be sometimes used interchangeably, despite possibly having slightly different technical meanings. Those skilled in the art may recognize that embodiments of the invention may be applied to involve each of, or some or more of these technical procedures—thus treating or considering such procedures in a manner similar or equivalent to each other.

The resource reallocation hub 400 may, in some embodiments, include a resource classification and grading engine, and/or a resource exposure engine, such that the resource reallocation hub 400 may provide classification and/or grading, and/or exposing of computer resources. In some embodiments, resource classification and grading engine and/or resource exposure engine may be for example functionally equivalent or be included in the policy engine (see discussion regarding policies and grading herein); those skilled in the art may recognize that such modules and/or engines and/or component may be combined and/or separated in different embodiments of the invention.

Embodiments may compose a plurality of computational resources into one or more larger resources, or decomposing one or more of the resources into a plurality smaller resources. For example, in some embodiments, a resource reallocation hub 400 may include a resource transaction or reallocation engine, and/or a functional resource composer, and/or local resource interfaces, and/or transactional resource interfaces, such that the resource reallocation hub 400 may provide reallocation and dynamic composition of granular individual resources of multiple types into functional resources of multiple types that may be allocated to workload execution instances 410 regardless of their physical placement and association (e.g., both local and remote). One skilled in the art may recognize that, as for additional components considered herein, modules and/or engines and/or component may be combined and/or separated in different embodiments of the invention.

In some embodiments, a resource reallocation hub 400 in some embodiments may include interconnecting interfaces, and/or networks, and/or fabrics (or any combination thereof) for accessing resources regardless of their physical placement and association (e.g., both local and remote).

Resource reallocation hub 400 and any of its components may, in some embodiments, be implemented individually in hardware, firmware, software or any combination of the above, whether physical, logical or virtual. Those skilled in the art may recognize that various components of resource reallocation hub 400 may vary in different embodiments of the invention and may be co-located within close proximity (e.g., on the same platform), or distributed in multiple different places (e.g., for example some processing stages may be executed remotely).

A resource reallocation hub 400 in some embodiments may be implemented as a hardware/firmware/software block within an SoC, FPGA, SmartNIC, GP-CPU, NVMe Storage Device, PCIe Switch, CXL Switch, Memory Devices of any type, GP-GPU, Node Controller (e.g., QPI/UPI Node Controller) or any other electronic components, devices, cards or systems. Such systems may be or include components such as shown in FIG. 1.

Resource reallocation hub 400 may, in some embodiments, take a physical form factor of a PCIe card, CXL card, CCIX Card, OCP card, mezzanine card, appliance placed within a rack, or integrated as a component onboard these form factors, or as part of any other form factor.

In some embodiments, multiple resource reallocation hubs operate simultaneously with overlapping resources (e.g., for redundancy), and/or with subsets of the resources (e.g., different clusters, departments, etc.).

Previous solutions addressed the allocation of complete workload execution instances (such as allocation of complete VMs or containers), whereas resource reallocation hub 400 addresses, among other targets, granular allocation of the individual resources and derived functional resources that make up the workload execution instance itself. For example, contemporary orchestration engines seek to find a server machine with available resources to fit a complete VM of size (A cores, B memory, C storage, D networking, etc.), whereas resource reallocation hub 400 addresses the discovery of independent granular assets and derived functional resources (e.g., CPU NUMAs, processor cores, memory DIMMs, NVMe storage elements, Ethernet networking) and their composition and dynamic attachment into a workload execution instance—as for example manifested in appropriate data structures and computational procedure as further demonstrated herein.

Resource reallocation hub 400 in some embodiments may be environment-agnostic, while previous solutions addressed only virtual environments (such as VMs and containers). Thus, addressing granular resource allocation by resource reallocation hub 400 of the present invention may also be applied for physical workload execution instances (e.g., bare metal servers).

Resource reallocation hub 400 in some embodiments may dynamically and continuously monitor the individual resources and functional resources of a workload execution instance (which may for example be established, as known in the art, to service a resource transaction or a request for such transaction) and transparently allocate/de-allocate/reallocate/migrate granular parts or “slices” of assets and/or resources which may for example already be in use by other workload execution instances. In contrast, previous solutions addressed the allocation problem as a one-time semi-static flow that completed when the virtual workload execution instance is placed or re-placed (e.g., VM migration) and then started/resumed.

Resource reallocation hub 400 in some embodiments may be allocation-agnostic, hence addressing also allocated functional resources, while previous solutions addressed the discovery and assignment of only unallocated functional resources. For example, previous solutions look only for unallocated resources (e.g., on servers) to fit a complete workload execution instance (e.g., look for a server with at-least unallocated A cores, B memory, C storage, D networking, etc.), whereas in some embodiments of the invention resource reallocation hub 400 may monitor all functional resources regardless of their allocation state, and makes additional tiered allocations to already-allocated but low-utilized functional resources (which may for example involve decomposing functional resources into their counterparts, e.g., as illustrated in procedures and data structures such as Procedures I-II and Tables 1-3 used in some embodiments of the invention; see also corresponding discussion herein).

Resource reallocation hub 400 in some embodiments may be topology-agnostic since it may not necessarily depend on or require a particular datacenter, infrastructure, system, platform or device topologies. For example, it may not require datacenter resources to be arranged in servers placed in racks and interconnected via ToR (Top-of-Rack) Switches or MoR (Middle-of-Row) switches, nor it requires a leaf-spine topology. Furthermore, Resource reallocation hub 400 in some embodiments may be applied to disaggregated topologies (e.g., full or partial resource disaggregation), to pooled topologies (e.g., full or partial resource pooling), to converged infrastructures and also to HCIs (Hyper Converged Infrastructures). Embodiments may for example automatically allocate, extract, harvest, or provision resources and/or assets found in multiple locations and machines in order to service for example a single given transaction (e.g., based on policy and/or grading for the transaction as well as for resources and/or assets; see further discussion herein).

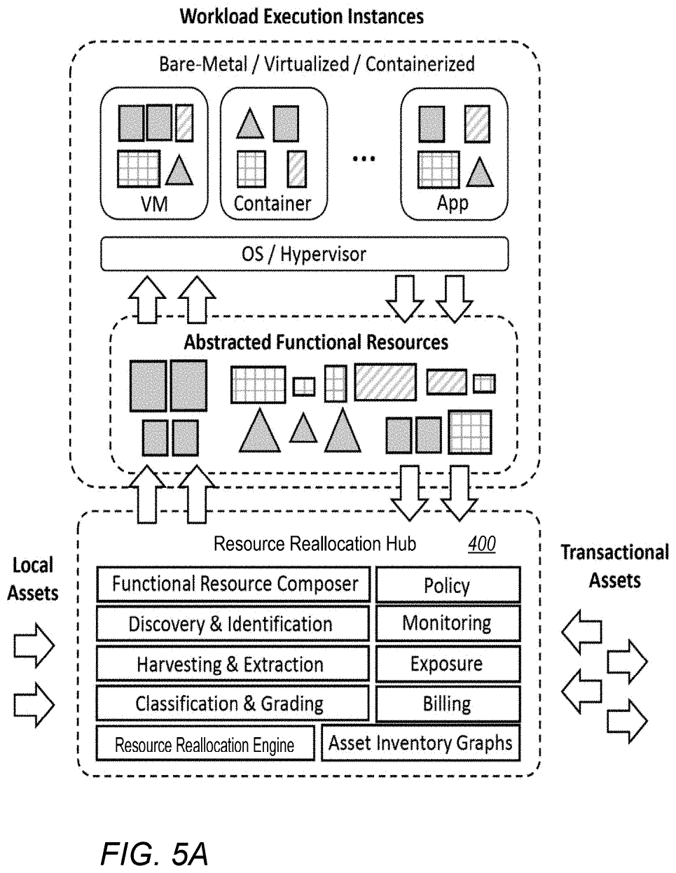

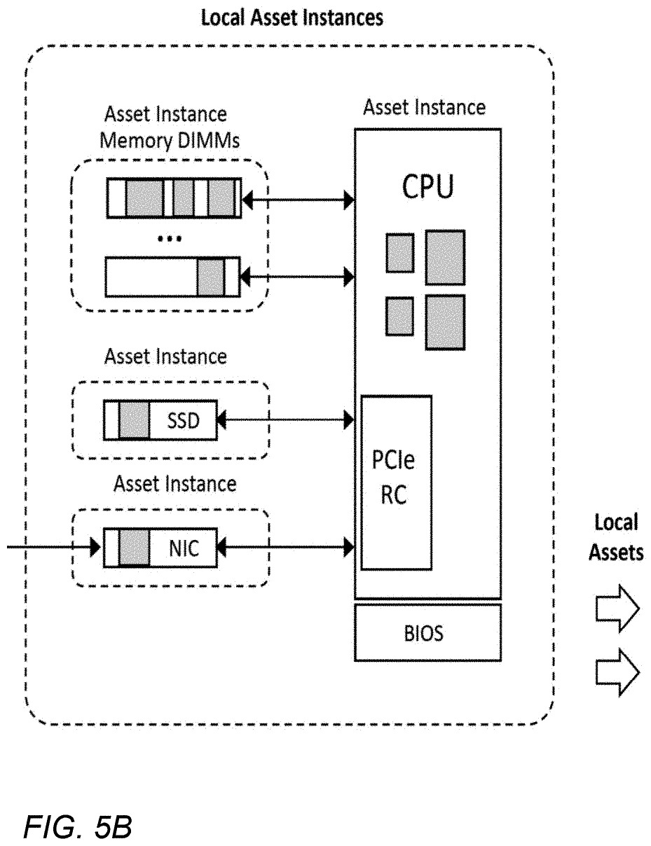

Reference is made to FIGS. 5A-5B, showing a block diagram of the resource reallocation hub 400 within a platform 500, according to some embodiments of the invention.

A resource reallocation hub 400 in some embodiments may be embedded onto a platform, such as the platform shown in FIG. 3, so at to achieve the platform 500 shown in FIGS. 5A-5B. Resource reallocation hub 400 in some embodiments may be embedded such that the functional resources may be shared with resource reallocation hub 400.

In some embodiments, each platform (e.g., a server) provides a platform-level resource reallocation hub.

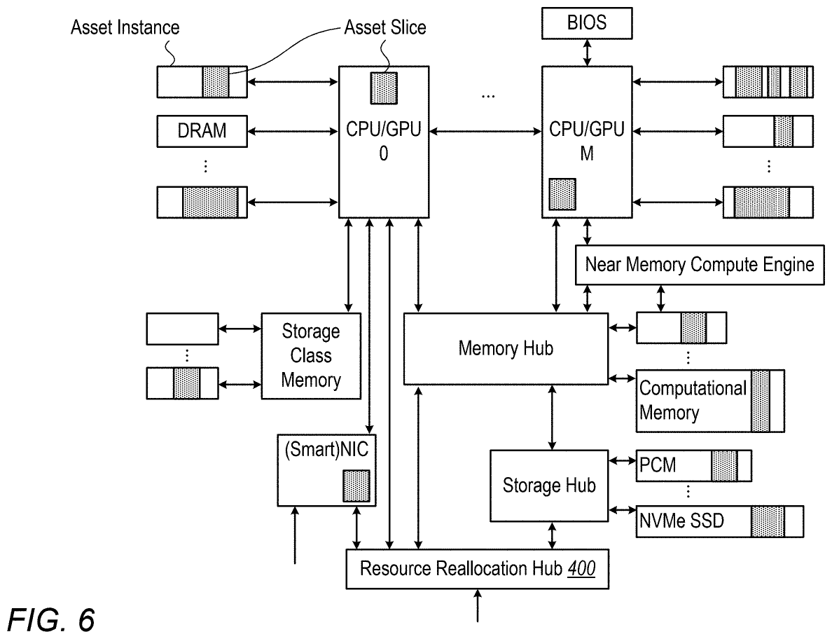

Reference is made to FIG. 6, showing a block diagram of component level of the resource reallocation hub 400 within the platform 500, according to some embodiments of the invention.

Resource reallocation hub 400 in some embodiments may be embedded onto a platform, such that the resource reallocation hub 400 communicates directly with the storage hub and/or the memory hub and/or the CPU/GPU.

In some embodiments, the resource reallocation hub 400 may communicate with the NIC, e.g. in order to receive resource and/or asset transaction requests as further described herein. For example, the NIC may communicate with a first network (or fabric), while the resource reallocation hub 400 may communicate with a second network (or fabric).

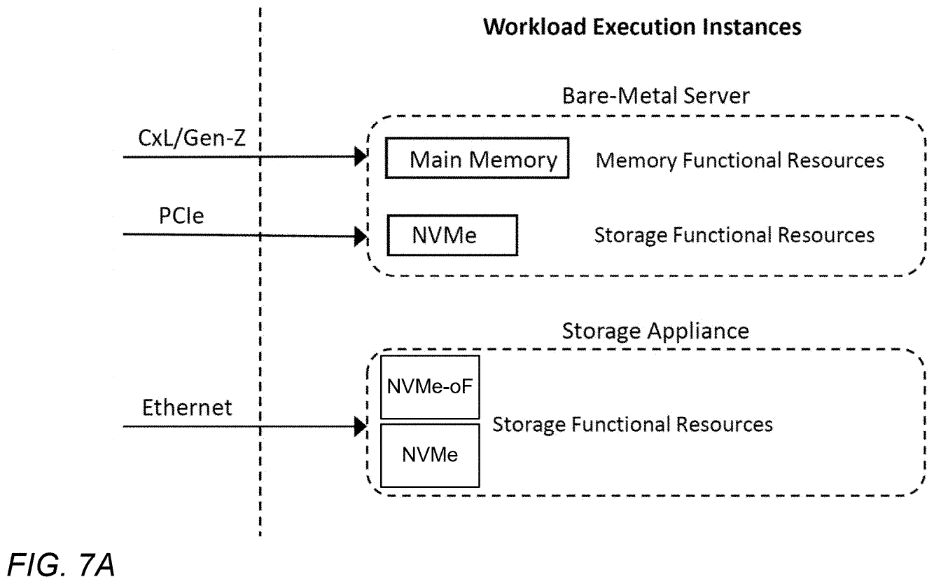

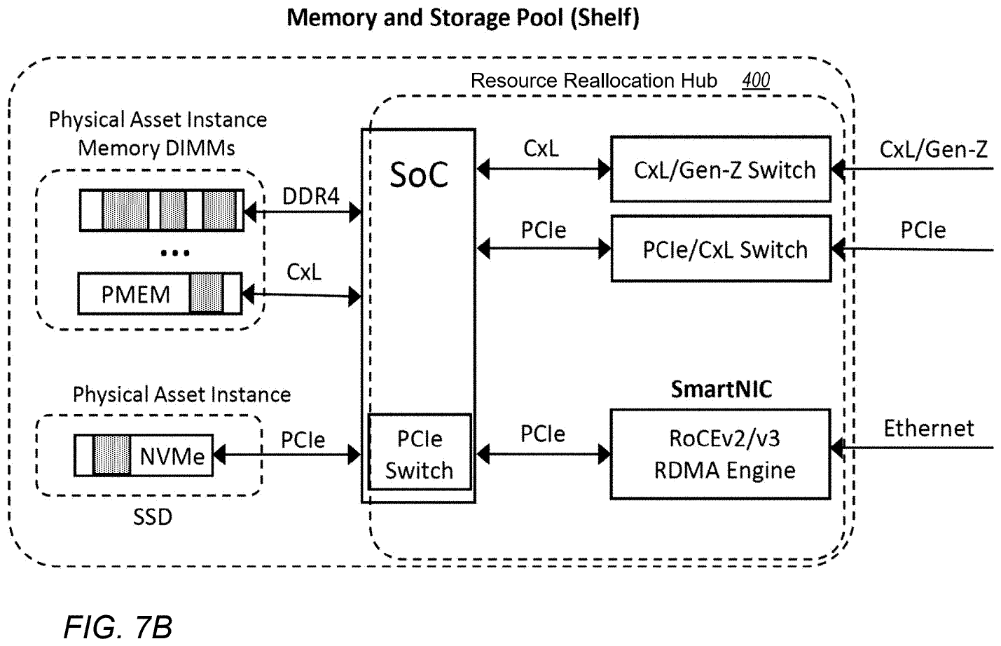

Reference is made to FIGS. 7A-7B, showing a block diagram of the resource reallocation hub 400 in various resource pooling topologies, according to some embodiments of the invention.

For example, the resource reallocation hub 400 may perform computer resource reallocation and/or migration and/or pooling with multiple DDR, and/or PCIe, and/or CXL and Gen-Z interfaces or fabrics for connecting to local memory, and/or local NVMe storage, and/or remote persistent memory, and/or remote GPUs, etc.

In some embodiments, reallocation or transactional resources at resource reallocation hub 400 may receive memory resources from physical resource memory DIMMs, passing to the bare-metal server (remote, e.g., in-rack): as functional resource for main memory. For example, a physical resource in the form of multiple DRAM DIMM memory modules attached to an SoC, may provide memory functional resources via a rack-level CXL fabric to a workload execution instance in the form of an operating system (OS) running within a bare-metal server within the same rack.

In some embodiments, reallocation or transactional resources at resource reallocation hub 400 may receive storage resources from physical resource memory DIMMs, passing to the bare-metal server (remote, e.g., in-rack): as functional resource for storage (e.g., NVMe device). For example, a physical resource in the form of multiple DRAM and PMEM DIMM memory modules attached to an SoC, may provide storage functional resources via a rack-level PCIe fabric to a workload execution instance in the form of OS running within a bare-metal server within the same rack.

In some embodiments, reallocation or transactional resources at resource reallocation hub 400 may receive storage resources from physical resource SSD/NVMe, passing to a storage appliance (remote, e.g., in-rack): as functional resource for storage (e.g., NVMe device). For example, a physical resource in the form of an NVMe device attached to an SoC and then via an embedded PCIe Switch to a SmartNIC, may provide storage functional resources via NVMe(oF)m e.g., via RoCEv2/RoCEv3 (RDMA over Converged Ethernet) RDMA fabric, to a workload execution instance running over a remote storage appliance.

In some embodiments, resource and/or asset topology or connectivity information of the computing resources may be mapped (e.g., according to resource and/or asset identifiers or addresses within for example a particular machine or computing system), where resource and/or asset policies and/or grading may be for example based on the mapped topology (taking into consideration, for example, which resources may be composed into a functional resource in a satisfactory manner e.g. based on compatibility and/or physical proximity for some or all or the former). In some embodiments, mapped topology or connectivity may be stored as part of various data structures which may be used by some embodiments of the invention (e.g., as a text file linked to Table 2 as further demonstrated herein).

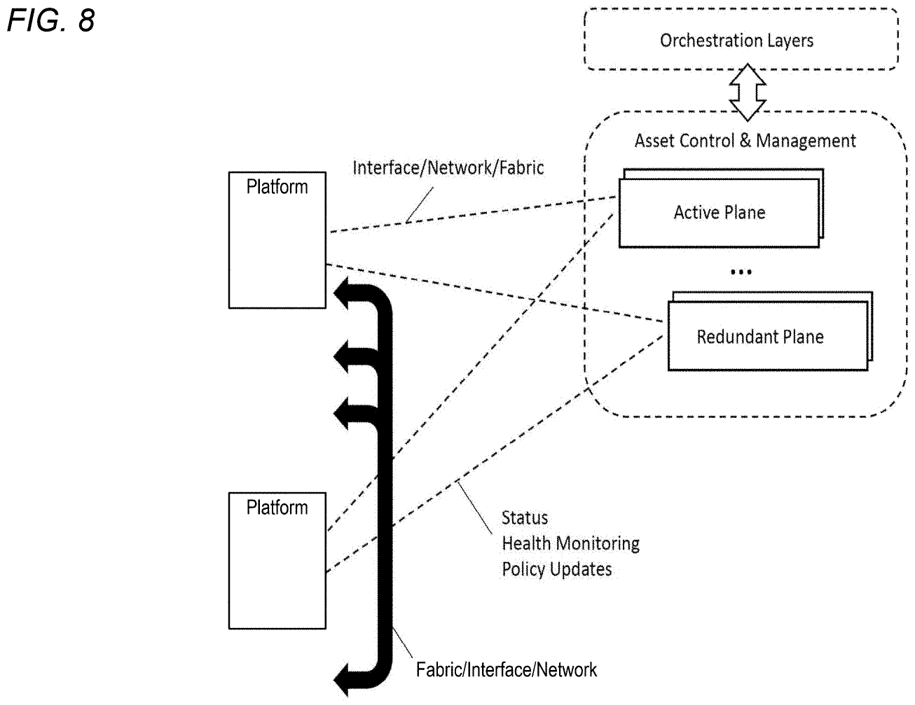

Reference is made to FIG. 8, showing a block diagram of resource reallocation hubs that are interconnected via fabric, according to some embodiments of the invention. Multiple platforms 800, such as a server, SoC, platforms on chip, MCP, etc. may share computer resources with the resource reallocation hubs 400 of each platform 800.

Resource reallocation hub 400 in some embodiments may be interconnected via interfaces, networks, or fabrics (or any combination thereof) for communicating with other resource reallocation hubs, such as for producing and consuming resources, or any other programmable user-defined messaging between resource reallocation hubs. For example, periodic status query, monitoring, health event reporting, topology discovery, asset grading, etc.

In some embodiments, a resource control and management module may manage resources of the plurality of resource reallocation hubs in order to determine at least one of: status, health monitoring, policy updates, interfaces, etc.

Resource reallocation hub 400 in some embodiments may communicate indirectly over other interfaces, networks, or fabrics (or any combination thereof) that are available via other resources or other resource reallocation hubs it is interconnected to.

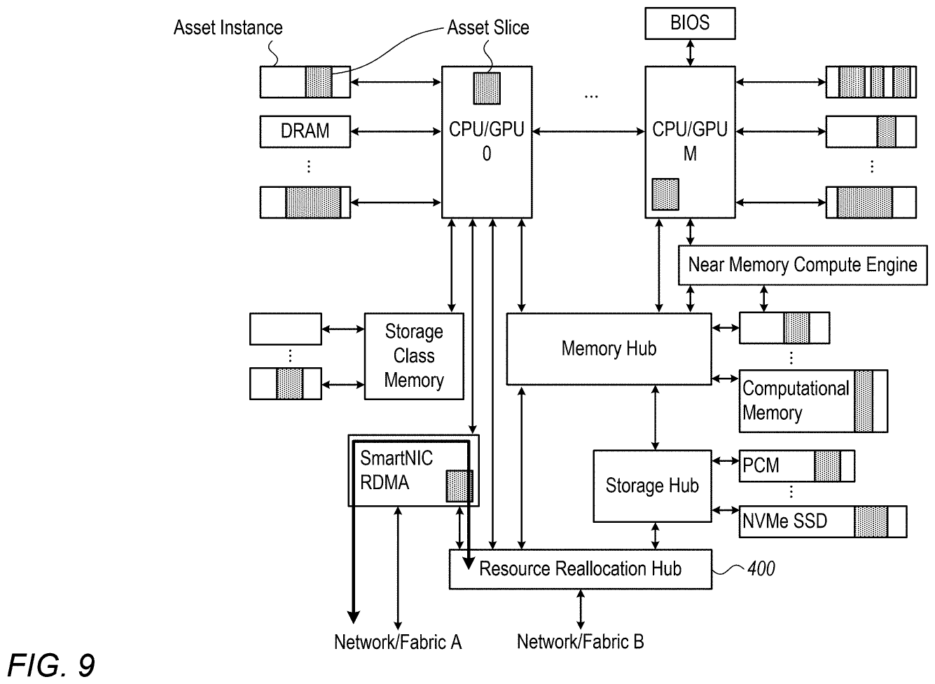

Reference is made to FIG. 9, showing a block diagram of a platform with resource reallocation hub 400 with indirect communication, according to some embodiments of the invention. The double-sided arrow in FIG. 9, from resource reallocation hub 400 and to the network/fabric A, may indicate the direction of indirect communication, for instance as applied to the platform shown in FIG. 6.

Resource reallocation hub 400 in some embodiments may communicate over an RDMA transport via a SmartNIC, and/or communicating via an InfiniBand card.

Referring back to FIG. 4, resource reallocation hub 400 may include a policy engine to control the operational aspects of resource reallocation hub 400.

Resource and/or asset and/or request and/or transaction policy or policies as referred to herein may be used interchangeably with for example grading levels and any rule or a set of rules which may be determined based on data and/or metadata and/or information included in one or more of the data structures and/or reflected in procedures and/or processes and/or historical information of executed procedures and/or processes which may be used in or carried out by some embodiments of the invention (including, but not limited to, the data structures and procedures disclosed as non-limiting examples herein—e.g., Tables 1-3 and Procedures I-II). In this context, any rules and/or conditions and/or criteria, or any sets of such, which may determine which resources and/or assets may be chosen for example to service a transaction request, or for being reallocated to service a given transaction or transaction request—or which may determine which transactions may be migrated to alternative resources and/or assets—may be referred to as a policy. Embodiments may thus determine (for example by a policy and grading engine or module) a policy for, or to be applied to, a request and/or for resources and/or assets and/or for execution instances as for example reflected in data structures and procedures which may be used and/or carried out by some embodiments of the invention (e.g., non-limiting example Procedures I-II and Tables 1-3). In some embodiments of the invention, policies and/or conditions and/or criteria may comprise information or settings for at least one of: frequency of resource monitoring, resource type, resource utilization levels, resource connectivity or topology, grading, urgency level, command queue depths, cache hierarchy utilizations, hit/miss ratios, power consumption, temperature, duty cycle, and historical data of such parameters, e.g. as further discussed herein.

Some embodiments of the invention may change or update for example policies and/or conditions and/or criteria based on one or more of the information or settings included in information or settings such as for example the above.

For example, policies may include resource discovery and identification policies to control and/or manage resource discovery and identification performed by the resource reallocation hub.

In another example, policies may include resource access control policy to control and/or manage resource security, e.g., which workload execution instances (which may for example utilize functional resources to service a given resource and/or asset transaction or transaction request, or a plurality of transactions and/or requests as further discussed herein) may use functional resources extracted from a particular resource or group of resources.

In another example, policies may include resource monitoring policies, to control and/or manage monitoring procedures, such as which resources to monitor, how frequently (such as periodic sampling, random sampling), etc.

In another example, policies of the policy engine may include resource exposure policy, to control and/or manage which resources to expose and/or hide (for example from resource reallocation hub 400 or from another, different resource reallocation hub—as for example may be reflected in data structures such as for example demonstrated in Tables 1-3), to what extent, where to expose (e.g., local platform only, rack/cluster-level, etc.).

Some embodiments of the invention may generally employ policies and/or grading in order to automatically choose resources and/or assets that are appropriate to service a given transaction request—see further discussion herein (note, in particular, procedures I-II which constitute non-limiting examples for the use of such gradings).

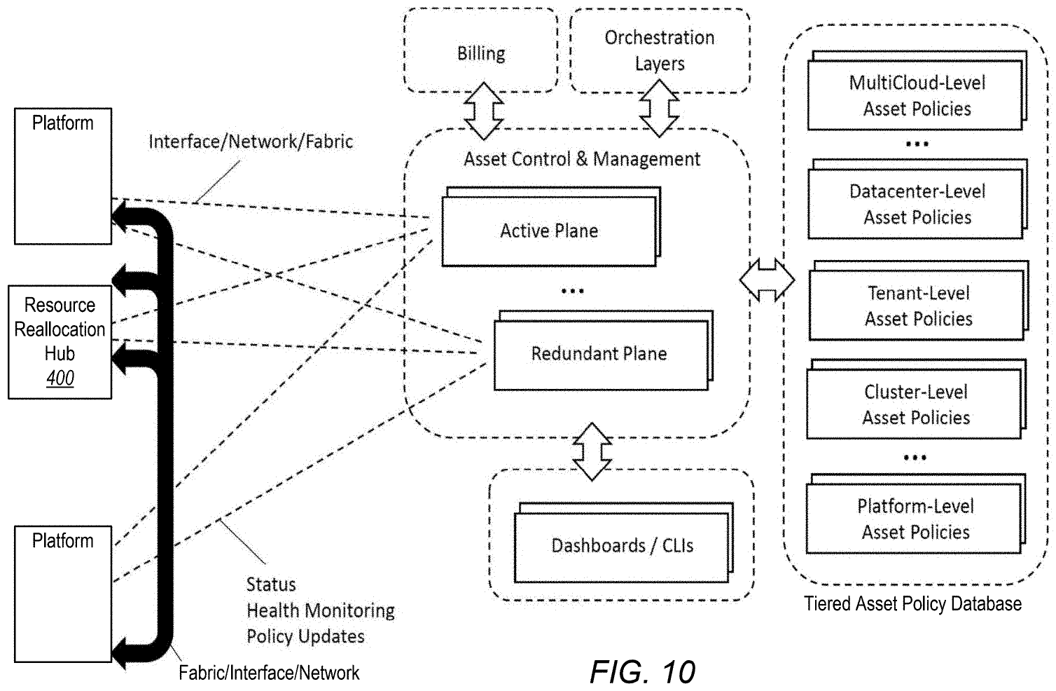

Reference is made to FIG. 10, showing a block diagram of a tiered resource policy database, according to some embodiments of the invention.

The policy engine may include a combination of directed policy entries from the resource control and management plane, and cached policy entries from the tiered resource policy database, that are associated with resources monitored by and associated with the resource reallocation hub.

For example, resource reallocation hub 400 in some embodiments may expose only persistent memory resources and only to a particular set of workload execution instances and/or currently executed transactions associated with workloads that benefit significantly from the use of persistent memory (e.g., keep a scarce resource to workloads where it matters most).

In some embodiments, the tiered asset policy database includes multiple levels or domains of policy control, such as platform-level resource policies, cluster-level resource policies, tenant-level resource policies, datacenter-level Asset policies, CSP-level resource policies, multi-cloud-level resource policies (for transacting assets across multiple clouds, multiple CSPs), etc.

Embodiments of the invention may identify (for example in a resource and/or asset monitoring database as described herein) a plurality of computing resources to service a given resource and/or asset transaction or transaction request, or a plurality of such. For example, referring back to FIG. 4, resource reallocation hub 400 may include a resource discovery and identification engine. In some embodiments, the resource discovery and identification engine may use multiple methods to discover resources, such as by querying the platform BIOS, querying the OS/Hypervisor running on the platform via special drivers or other software components, reading device identification registers, querying the orchestration layers, locating pre-assigned assets via the tiered asset policy database, and the like. In some embodiments of the invention, discovering and/or identifying resources may involve searching a corresponding database or appropriate data structure which may describe for example the current state of a plurality of resources and/or policies associated with these resources (as may reflected in data structures such as for example Tables 2-3). For example, appropriate ACPI tables specified in the Unified Extensible Firmware Interface (UEFI) specification may be for example written by the platform firmware and describe the platform topology (e.g., amount of memory, size, and additional physical properties describing for example PCIe and storage devices, number of compute nodes and cores, their state of use and/or occupation, and the like). ACPI tables may thus be for example read by the OS and may be used by it in order to gain knowledge on the platform topology, as well as on capacities and capabilities of for example non-granular or native resources.

A non-limiting example ACPI table which may be used in some embodiments of the present invention is illustrated in Table 1.

TABLE 1

| Field | Resourceᵢ | Resourceⱼ | . . . |
|---|---|---|---|
| Type | 1 | 2 | . . . |
| Flag | 1 | 1 | . . . |
| Length | 1 | 2 | . . . |
| Reserved | 3 | 3 | . . . |
| . . . | . . . | . . . | |

Where a plurality of indices (n=1, 2, . . . ) denote characteristics or properties with regard to a plurality of fields for a plurality of computer resource and/or components as identified by the system. In such manner, for example, Type=n may indicate that Resourceᵢ corresponds to a CPU node (while Type=n+1 may denote for example a memory cell or chip); Flag=n may indicate that Resourceᵢ resides on a particular platform n, which may for example be reflected in topology or architecture and indicate the connectivity of this resource to additional resources found in the system and/or platform; Legnth=n may correspond to the total capacity of Resourceᵢ (this may be useful in case where, e.g., a plurality of resources of Type=n differ by their capacity—for example in case where two types of CPU nodes which differ by their computation capacities are identified or found within the platform; in some embodiments, however, different capacities may be reflected in the “Type” field instead of in “Legnth”); and Reserved=n may correspond to the state or occupancy of Resource′ (for example, Reserved=1 may denote an “idle” or “available for use” status, Reserved=2 may denote a “partly available” or “partly occupied” status, and Reserved=3 may denote aa “fully occupied” or “fully unavailable” status). Additional indices and fields may be used in different embodiments of the invention. Those skilled in the art may recognize that alternative databases or appropriate data structures describing for example the properties and state of a plurality of resources, for example in the context of resource and/or asset identification, may be used in different embodiments of the invention.

In some embodiments, the resource discovery and identification engine may collect and/or search various types of information about the resource such as: resource and/or asset physical location, resource IDs (e.g., Vendor ID, device ID, model, vendor serial numbers, resource inventory SNs, PCIe BDF identification, etc.). In some embodiments, the resource discovery and identification engine may collect topology information, for placement and interconnect relative to resource reallocation hub 400 performing the discovery and identification.

According to some embodiments, the scope of resource discovery and identification performed by resource reallocation hub 400 may dictated by for example the associated resource discovery and identification policies in the policy database.

For example, according to one setting of platform-level resource policies, resource reallocation hub 400 may be configured to be local, e.g., attached locally to a platform (e.g., a server) may query and discover only local resources directly-attached to the platform. In another example, according to another policy setting, resource reallocation hub 400 may further query and discover other resources not directly attached to the platform. Such scenario is applicable, for example, in embodiments where only some of the platforms in the datacenter include platform-level resource reallocation hubs.

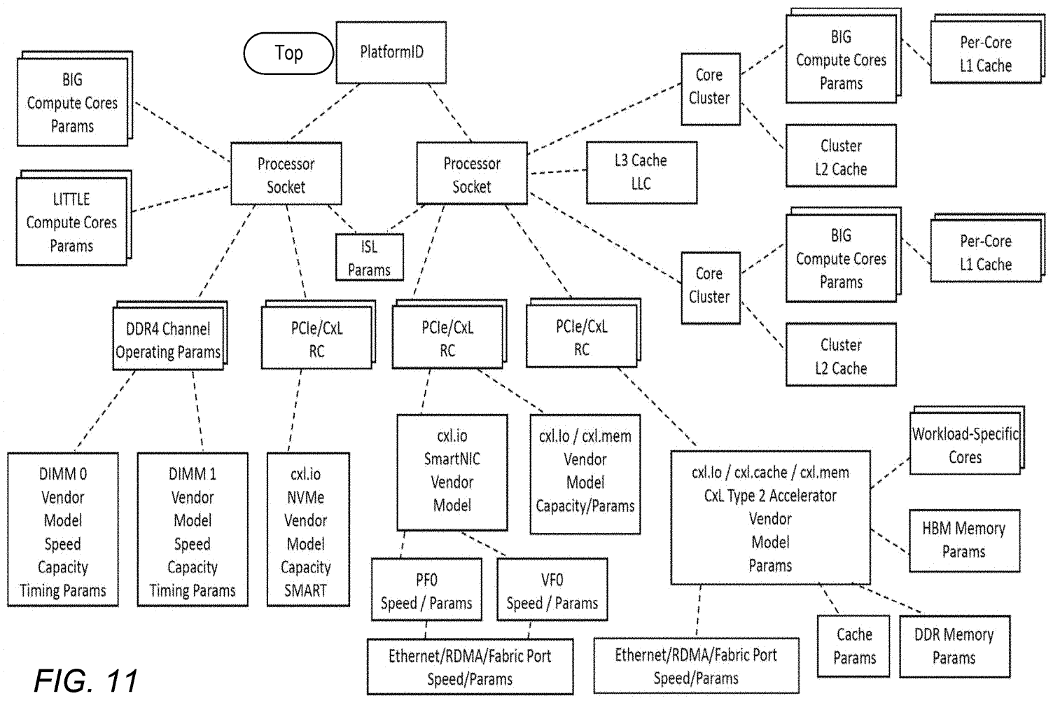

Reference is made to FIG. 11, showing a platform level view of a resource inventory graph, according to some embodiments of the invention (for example to store and/or describe resource and/or asset connectivity and/or topology information). When using the inventory graph structures, it may be possible to represent and maintain the resources discovered and identified by the resource reallocation hub.

In some embodiments, such resource inventory graphs may be refreshed or updated periodically and/or by resource change events (e.g., hot unplug event of a PCIe card, hot plug event of a memory DIMM, dying gasp of a silicon photonics engine, etc.).

In some embodiments, such resource inventory graphs may be stored within resource reallocation hub 400, within instances of the resource control and management plane, within dashboard instances, or any combinations thereof (they may also be linked, for example, to data structures such as e.g. Tables 2-3).

In some embodiments, such resource inventory graphs may be constructed, partitioned and/or updated at platform-level, rack-level, rack/cluster-level, pod-level, datacenter-level, or any other selectable partitioning.

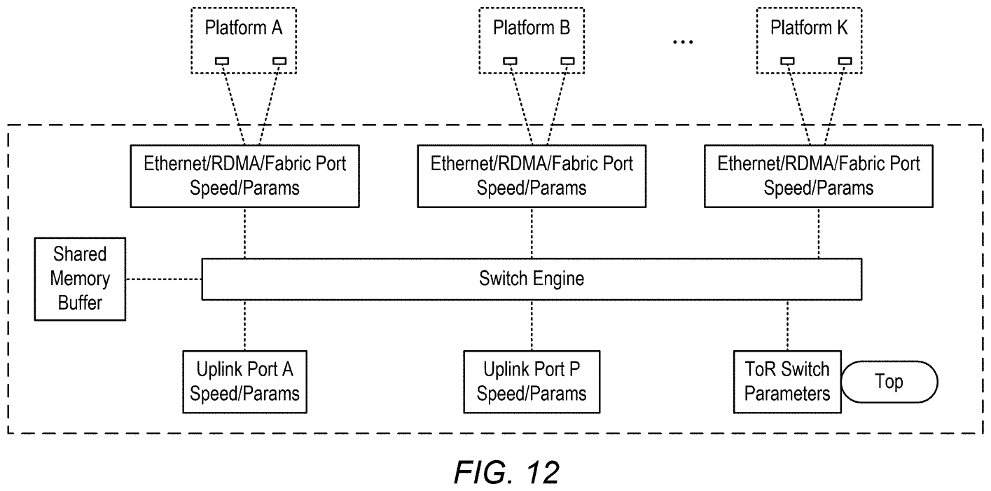

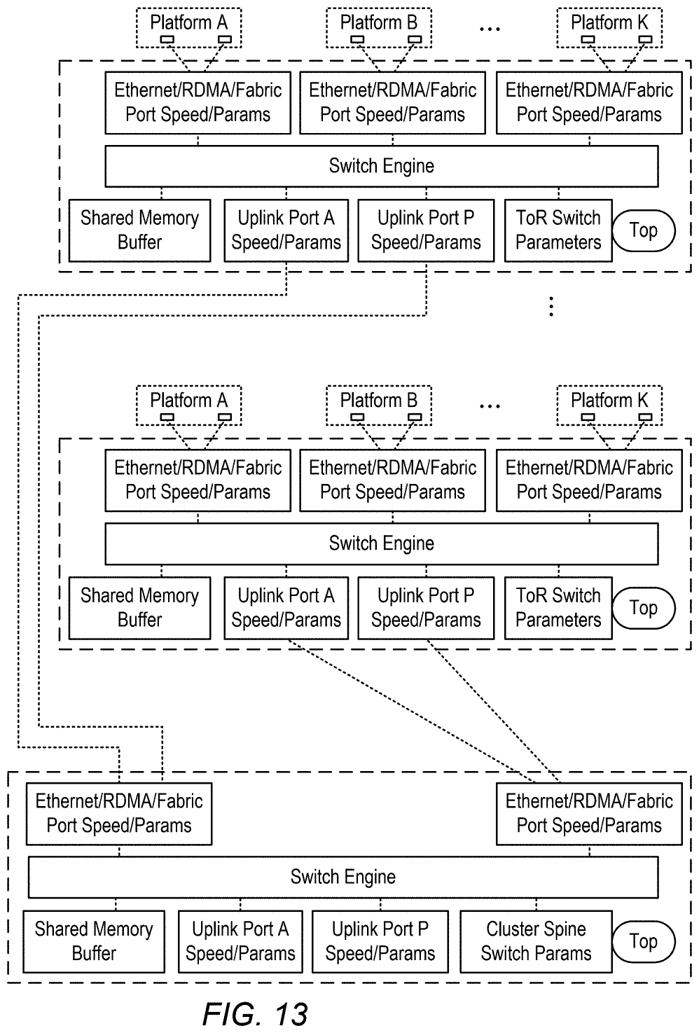

Reference is made to FIGS. 12 and 13, showing a rack level view and a cluster level view, respectively, of a resource inventory graph, according to some embodiments of the invention.

A plurality of resource reallocation hubs in some embodiments may periodically send unsolicited reports generated for example based on a plurality of data structures used by embodiments of the invention, along with additional metadata such as resource reallocation hub 400 status and statistics which may be or may include information regarding asset status, utilization, health information, and historical such information (which may be for example described by or embedded in data structures identical or similar to e.g. Tables 2-3).

In some embodiments, the resource reallocation hubs may also exchange reports with other resource reallocation hubs, such as by using unicast directed methods, targeted multicast or broadcasts. Exchange of reports may assist in maintaining a coherent view of resource information, in particular of assets in close topological proximity. In some embodiments, the resource control and management plane may periodically send policy updates and query information to resource reallocation hubs.

Referring back to FIG. 4, the resource reallocation hub 400 may include a resource monitoring engine. In some embodiments, the resource monitoring engine may continuously monitor programmable user-defined parameters of resources (or subsets of resources) marked in the resource monitoring policy assigned to it by policy updates from the resource control and management plane. Such resource parameters may include the resources utilization levels, load, command queue depths, cache hierarchy utilizations and hit/miss ratios, power consumption, temperature, duty cycle, etc. and history data of such parameters along multiple programmable time windows.

In some embodiments, the set of resources marked for monitoring by the resource monitoring policy is represented by resource monitoring domains defined for example over resource inventory graph structures. In some embodiments, individual resources, or groups of resources, may be associated with different policies and/or profile parameters.

In some embodiments, the resource monitoring engine may provide or choose candidate resources and/or assets for harvesting and extraction. Furthermore, in some embodiments, the resource monitoring engine may monitor groups of assets for purposes of status and health data gathering only, e.g., for display on dashboards.

In some embodiments, the resource monitoring policy defines additional profile parameters such as the frequency of resource probing, methods of probing, (e.g., periodic asynchronous sampling, random sampling, event driven monitoring), thresholds and conditions for triggering an action (e.g., reacting to failures in assets by reassigning other assets), etc.

In some embodiments, the resource monitoring engine may query workload management instances (either local on the platform, which may be for example a particular physical machine such as a hypervisor, or global, such as orchestration layers in the datacenter), or may collect information from other hardware, firmware and software resources to gather asset allocation state, access patterns and usage patterns of workloads execution units in order to detect low-utilized, infrequently used, or idle resources.

In some embodiments, the resource harvesting and extraction engine performs at least one of the following operations: harvesting—collecting and maintaining an inventory of unallocated resources available for composition into functional resources, and/or extraction—collecting and maintaining an inventory of allocated resources based on their actual utilization level, load, duty cycle data, or any other similar usage data, attempting to discover allocated but low-utilized resources that may be repurposed.

For example, the resource harvesting and extraction engine may recompose a low-utilized and/or rarely-used resource into another type of functional resource, for instance, recompose low-utilized and/or rarely-used persistent memory resource slice into a non-volatile storage device with block-semantics.

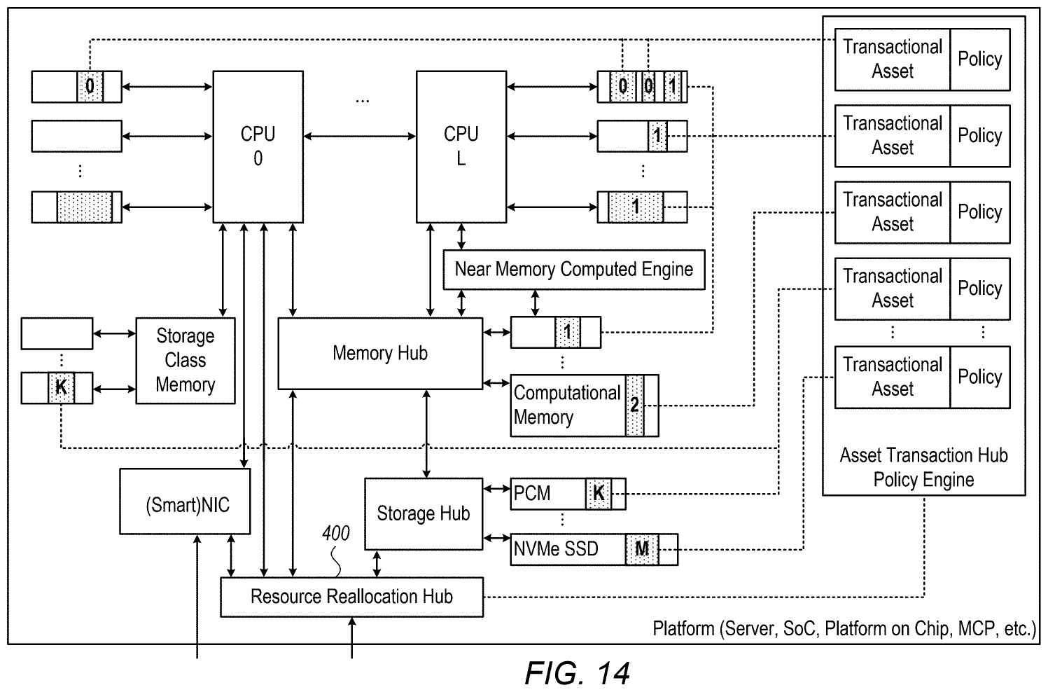

Reference is made to FIG. 14, which is a block diagram of a resource extraction engine for transactions, according to some embodiments of the invention. The resource extraction engine may use utilization, load, duty cycle or any other similar information collected by the resource monitoring engine.

In some embodiments, the resource harvesting and extraction engine and any of its components may be implemented in hardware, firmware, software or any combination of the above, whether physical, logical or virtual. Its components may be co-located within close proximity (e.g., on the same physical platform), or distributed in multiple different places (e.g., for example some processing stages may be executed remotely). For example, the harvesting operation may use a software module within a host hypervisor to query for unallocated resources.

In some embodiments, the resource extraction policy controls the operation of the resource extraction engine and defines the relative eagerness of a workload execution instance to extract and transact its associated resources with other workload execution instances, as essentially expressed via higher or lower ask prices for the extracted assets.

Referring back to FIG. 4, the resource reallocation hub 400 may include a resource classification and grading engine. In some embodiments, the resource classification and grading may perform classification and/or grading.

For example, classification may include determining the association of a resource to a class or a set of classes, based on resource type and properties. Grading may refer to a programmable user-defined set of functions that determine the relative merit of a resource when associated with a particular class. A grading function of a resource may be based, for example, on its inherent characteristics (such as nominal speed, MTBF (mean time between failures), power-on hours, power cycle count, recoverable/unrecoverable ECC/CRC/FEC errors, remaining useful life, etc.), its available capacity/bandwidth, load history, access latency history, response latency, utilization level history, distance from the location of a particular workload execution entity on a resource inventory graph, path congestion history along paths connecting the asset to a particular workload execution entity, biased response latency history (measured from location on resource inventory graph), etc.

In some embodiments, the benefit of any particular resource type to a particular workload execution instance varies depending on the topology of the system and other parameters such as load or congestion. For example, a local memory resource may provide a higher benefit to a local workload, than using a remote memory asset.

In some embodiments, biased response latency may be used as a factor for grading a resource, based on the response latency perceived from different topology locations on the resource inventory graph.

In some embodiments, the use of biased response latency significantly augments the existing conventional use of NUMA distances, by providing granular per-resource latency/distance information, rather than an aggregated and lumped NUMA latency that often may not truly represent the performance SLA (service level agreement) that can be expected from that asset. Biased response latency may be a dynamic measure that changes based on actual system behavior, rather than a NUMA latency which is determined statically at a certain point of time, usually at system boot.

According to some embodiments, grading results may be updated periodically, for example, in order to reflect temporary congestion over the resource itself, over the (e.g. physical) platform, or over the fabric, etc.

In some embodiments, different workload execution entities may calculate different grading results for the same resource, reflecting the differences in paths relating to the underlying topology, or other factors that affect the relative merit of that resource to a particular workload execution instance.

In some embodiments, grading results of memory resources may be reflected back to OS NUMA tables, so that the OS would be able to use the memory resources optimally using the conventional NUMA methods that are already in place.

According to some embodiments, the functional resource composer may compose abstracted functional resources from local assets and from transactional resources, or any combinations of thereof.

In some embodiments, the resource exposure module prepares one to many “ask descriptors” per each resource exposed locally on the resource reallocation hub 400, or exposed externally to other resource reallocation hubs. Multiple ask descriptors may reflect different eagerness or pricing for the particular resource, based on the identity of the consuming workload execution instance, e.g., an ask descriptor with a FREE pricing for that asset for a VM that belongs to the same tenant or organization, in contrast to an ask descriptor with a standard market ask pricing for a foreign VM that belongs to another tenant or organization.

In some embodiments, the resource transaction engine matches supply of resources with demand for that class of resources, via ask descriptors and/or bid descriptors. For example, a set of match policies may manage the operation of the resource transaction engine.

In some embodiments, matching supply and demand may be based on time and/or generation of the bid/ask descriptors, or based on FCFS (first-come-first-served), or based on priority+FCFS, or based on current bid/ask prices. In some embodiments, the match may be based on priority, such as prioritizing a match between VMs of the same tenant over a match between VMs of different tenants.

Once a match is made, the transaction engine may notify the parties resource reallocation hubs about the successful transaction and delists the resources. For example, delisting a resource may include removing that resource from a list of available or active computer resources.

In some embodiments, the resources may be reused and/or reallocated multiple times. For example, a resource may be exposed for transactions not by its original holder. In a similar manner, resource transactions may be migrated multiple times onto different resources.

In some embodiments, releasing a resource back to the original holder, when applicable and permitted, may be carried out by the resource transaction engine.

In some embodiments, in order to provide redundancy and system resiliency, the resource reallocation hubs may overlap their responsibility for resources so that a failure of one or more resource reallocation hubs may be recovered by other resource reallocation hubs taking their role.

In some embodiments, redundancy at the resource level, such as in memory and storage, may be dictated by redundancy policies that mirror, replicate, RAID, FEC or use other schemes for redundancy in order to increase the probability of data and system recovery in case of a failure of a resource.

Non-limiting examples for automatic, dynamic resource reallocation and/or resource and/or asset transaction migration procedures by resource reallocation hub 400 will now be provided in order to illustrate possible workflows and interactions which may be executed by resource reallocation hub 400 and the underlying modules which may be included in it. It should be noted that procedures and protocols may vary in different embodiments of the invention.

### Procedure I:

1. Receive, for example via a data network, a resource or asset transaction request for executing one or more computational processes and/or tasks (the request may conform to the example data structure for an asset transaction request provided herein).
2. Determine a policy and/or grading level for the request (for example by policy engine, based on for example request parameters as further demonstrated herein).
3. Lookup or search (for example by resource monitoring engine) a resource(s) and/or asset(s) monitoring database (which may include for example a plurality of computing resources and/or assets and a plurality of policies describing the resources as further described herein) to identify or find available assets and/or resources which may be used to service the request. If no such resources and/or assets are found, send an error message (e.g., human-readable message such as “unable to service the transaction” to an address associated with a sender of the request) and stop the procedure.
4. Choose or select one or more of the resources matching or corresponding to the policy and/or grading determined for the request.
   i. If, e.g., the only assets found available are of a policy and/or grade higher than that of the request—choose or select these available assets anyway.
   ii. If the only assets found available are of a policy and/or grade lower than that of the request, then:
      a. Search (for example in a resource and/or asset transaction database) e.g. for additional asset transactions of a policy and/or grade lower than the grade for the request under consideration, and choose one or more of the additional asset transactions associated with resources and/or assets matching the policy and/or grading determined for the request that, if made available, will be able to service the request; If no such transactions are found in the search, then send an error message (for example as a text file saying “asset transaction request cannot be serviced” to the address of the computing device from which the request was sent).
      b. Migrate the chosen additional transactions to available, alternative computing resources and/or assets (for example using the resource transaction or reallocation engine and the resource harvesting and extraction engine, based on policy and/or grading levels for e.g. both assets and transactions), or reallocate available, alternative computing resources and/or assets to service the chosen additional transactions, so as to free the assets and/or resources matching the policy and/or grading for the request; the identified assets and/or resources that may be made available as a result of the migration may accordingly be chosen for the next steps of Procedure I.
5. Of the resources and/or assets chosen or selected, compose and/or assemble a functional resource and/or workload execution instance (e.g. by functional resource composer) to service the request.
6. Allocate and/or extract and/or provision (e.g., by harvesting and extraction engine) the functional resource resources to perform or execute computational procedures and/or tasks included in the request (in other words, generate the requested transaction using the functional resource).
7. Document and/or record and/or update records associated with the transactions modified by previous steps of Procedure I (for example by a resources and/or assets monitoring database and a resource and/or asset transaction database as demonstrated herein, and according to the choosing and/or composing and/or allocating and/or provisioning of resources and/or assets as performed in previous steps).

Embodiments of the invention may allow choosing or selecting a plurality of specific resources and/or transactions and/or transaction requests according to a plurality of predefined conditions or criteria, or sets of such, as part of a resource reallocation or asset transaction migration procedures, such as e.g. the example procedures outlined herein. Another non-limiting procedure that may be used in some embodiments of the invention in order for, e.g., enable resource reallocation hub 400, which may include a plurality of different modules as described herein, to automatically manage asset transactions is outlined in Procedure II.

### Procedure II:

1. Monitor (for example by resource monitoring engine) and/or check a resource and/or asset monitoring database to identify resources and/or assets currently available for use (e.g. idle assets that are not currently used to service existing asset transactions). If no such resources and/or assets are found, send an error message (e.g., human-readable message such as “unable to service the transaction” to an address associated with a sender of the request) and stop the procedure.
2. Choose or select (for example by resource monitoring engine) currently available resources and/or assets according to a first set of one or more predefined conditions or criteria—e.g., based on having a policy and/or grade higher than for example grade level X (reflecting, e.g. the lowest grade of asset(s) currently in use). If no such resources and/or assets are found, send an error message for example such as the above and stop the procedure.
3. Monitor and/or check (for example by resource monitoring engine) e.g. a resource and/or asset transaction database (for example conforming to the format further demonstrated herein) to choose or select a given transaction (or a plurality of transactions) according to a second set of predefined conditions or criteria, such as for example transactions matching a given policy and/or grade level (for example the highest grade level of transactions currently being serviced), and/or transactions for which a transaction request has been received at a specific time slot (for example that corresponding to the earliest-received request among the transactions of the house highest grade level). If no such transactions are found, send an error message for example such as the above and stop the procedure
4. Check (for example by resource monitoring engine) if assets dedicated to service the chosen transaction(s) e.g. meet a third sent of predefined conditions or criteria (for example if at least some of these assets are graded lower than grade level X).
   i. If not—then monitor and/or check the transaction database to choose alternative transactions (e.g. the next transaction of the same policy and/or grade level and repeat steps 3-4 for the newly chosen transaction).
   ii. If so—then migrate (for example using the resource transaction or reallocation engine and the harvesting and extraction engine, based on policy and/or grading levels for e.g. both assets and transactions) one or more of the chosen or selected transactions or tasks included in the transactions from e.g. the assets fulfilling the criteria of step 4 to the assets chosen in step 2 (e.g. by first freezing or pausing the corresponding tasks and/or processes and the corresponding workload execution instance(s), and decomposing the corresponding functional resource(s) and/or by the functional resource composer)—or reallocate (and/or extract and/or harvest) one or more of the currently available resources to service one or more of the chosen transactions.
5. Repeat one or more of steps 1-4 to migrate additional tasks from different transactions currently being serviced or reallocate one or more of the currently available resources to service one or more of the chosen transactions for example so as to ensure optimal use of computing assets and/or resources e.g. according to the corresponding policy and/or grade levels for both transactions and assets and/or resources under consideration (the above steps may thus be performed for example so as to free resources and/or assets which may be identified as appropriate to service a given asset transaction request, or a plurality of transaction requests).
6. Document and/or record and/or update records associated with the transactions modified by previous steps of Procedure II (for example in a resources and/or assets monitoring database a resource and/or asset transaction database as demonstrated herein).
   In some embodiments, resource and/or asset allocation/reallocation processes and procedures such as for example Procedures I-II may thus result in e.g. allocating, and/or provisioning, and/or harvesting, and/or extracting one or more of the chosen resources to perform one or more of the tasks included in the transaction or transaction request under consideration. Such processes may involve using e.g. databases describing a plurality of for example: resources and/or assets, transactions to be serviced, and transaction currently being serviced by embodiments of the invention as further explained herein. Those skilled in the art would recognize that, aside from Procedures I-II, various alternative procedures including a plurality of different steps and/or actions (including e.g. multiple resource reallocations and/or transaction migrations) and involving different data structures may be performed and/or used in different embodiments of the invention. Such alternative procedures may include, inter alia, combinations of various steps from Procedures I-II—in addition to additional, alternative steps that may be known in the art.

A plurality of procedures and/or steps for example as the non-limiting examples outlines above may be repeated multiple times (for example in an iterative manner) in order to enable optimal or near-optimal utilization of computational resources and/or assets in accordance with the discussion herein.

A transaction request as referred to herein may be or may include various data structures, which may comprise for example text files, tables, databases and the like. One skilled in the art may recognize that data structures used as part of a transaction request may vary in different embodiments of the invention. A non-limiting example for such structure may be implemented e.g. in a text file such as:

### Sender: WEIZ Institute of Science

### Sender ID: [04001]

### Request_type: Standalone

Requirements: nCores=4, Mem=40 GB, Store=1 TB

### Urgency: High

Notes: “in order to execute a Monte-Carlo molecular dynamics simulation, the above resource requirements are needed to be found in a standalone computer (single box/machine) such that sources of calculation error are minimized.”

Transaction requests such as the above non-limiting example may thus include a plurality of fields and/or parameters which may be read, extracted, and used by some embodiments of the invention. Extracted parameters and/or details may be documented in dedicated databases, such as for example a resources and/or assets monitoring database, or a resource and/or asset transaction database as further demonstrated herein. The corresponding modules and/or engines which may be included in resource reallocation hub 400 (for example modules discussed herein) may make use of the extracted information in order to execute various resource reallocation and/or transaction migration processes and procedures (such as for example Procedures I-II illustrated herein). In some embodiments, a transaction request may for example correspond to or include a resource and/or asset reallocation request or instruction, or a computational task which may be required or may originate from a resource and/or asset reallocation procedure (such, e.g., example Procedures I-II demonstrated herein) or a corresponding reallocation decision (which may, e.g., correspond to updating the resource and/or asset monitoring database as described herein).

Embodiments may determine a policy for a resource and/or asset transaction request. For example, in some embodiments, a policy and grading engine may be configured to read the contents of a given transaction request (e.g. in the text file format provided herein) and determine for example a grade for the corresponding transaction, which may be further serviced using resources and/or assets managed by resource reallocation hub 400. Thus, some Sender IDs may be associated for example with a high grade (e.g., the highest available grade, which may be designated ‘A’, or a lower grade such as ‘C’, ‘D’, and so forth) by embodiments of the invention. Grading schemes may include predetermined rules and/or conditions for determining a particular grading for a given resource transaction request. A non-limiting example grading scheme employing such “if-then-otherwise” type rules which may be used in some embodiments of the invention may be, e.g.:
1. Check Urgency field in appropriate resource transaction request file which may be for example a text file as demonstrated herein).
   If Urgency=High, then set Grade=A.
   Otherwise—
2. Check Request_type.
   If Request_type=Standalone, then set Grade=A.
   If Request_type=Storage, then:
      Check Requirements.
      If: Store>5 TB, then set Grade=A
   Otherwise—set Grade=B.
      Those skilled in the art would recognize that various additional/alternative grading schemes and/or procedures, which may employ or include a plurality of different conditions of different types may be used in different embodiments of the invention.

Grading of transactions and/or of resources may accordingly be used for example to match a given transaction with the best available resources which may be used to service that transaction for example at a given point in time (see demonstrations in e.g. Procedures I-II and Tables 2-3 herein). Transaction requests may include a variety of additional and/or alternative fields (such as for example requirements for resources of specific types/by different manufacturers, for executing the requested transaction before a predetermined point in time, and so forth) as needed in order to service a plurality of transactions and/or transaction requests by different embodiments of the invention.

In some embodiments of the invention, a transaction request or a plurality of requests may (e.g., instead or in addition to the example data structure above) comprise or include components and/or data structures and/or programs required for servicing the request, for example executables which may accompany a specification of computational resources chosen to execute them. In such case, the contents of the request may be transferred and/or copied to the specified or chosen resource in order for the request to be serviced. In other embodiments, requests may only describe carrying out a task that a particular resource is already configured to execute (such as for example running a program already installed on the requested resource). One skilled in the art may recognize that the contents of transaction requests may thus vary in different embodiments of the invention.

In order to perform and/or execute various resource reallocation and/or migration processes and/or procedures (including, but not limited to, Procedures I-II), resource reallocation hub 400 may use of a plurality of databases and data stores organized in various formats (e.g., as tables, graph databases, and the like; one skilled in the art may recognize that formats and data structures may vary in different embodiments of the invention). Some embodiments may include for example a resources and/or assets monitoring database which may for example take the form illustrated in Table 2 and include for example functional resources and/or assets which may be composed or decomposed from, for example, resources identified by some embodiments of the invention (e.g., those included in an ACPI table such as Table 1 as described herein).

TABLE 2

| No. | Asset_ID | Asset_type | Asset_Contents | Asset_Connectivity | Policy/Grade | Availablility | Serv_Req |
|---|---|---|---|---|---|---|---|
| 1. | [01001] | Standalone | nCores: 4 | Link to a text file/table | A | Full | [03001] |
| | | | Mem: 40 GB | describing asset topology + | | | |
| | | | Store: 1 TB | additional parameters | | | |
| 2. | [01002] | Per_Memory | Mem: 500 TB | As above | B | Idle | N/A |
| 3. | [01003] | vCPU | nCores: 4 | As above | C | Idle | N/A |
| 4. | [01004] | Storage | Store: 3 TB | As above | D | Partially | [03002] |
| | | | | | | free | |
| . . . | . . . | . . . | . . . | . . . | . . . | . . . | . . . |

Resources and/or assets may thus be listed and/or documented in resources and/or assets monitoring database in order for resource reallocation hub 400 to determine for example which resources and/or assets are to service a given transaction request at a specific point in time. In some embodiments, resources and/or assets monitoring database may be updated periodically (e.g., every X seconds; where X may also for example be subject to changes e.g. based on the number of transactions being serviced by resource reallocation hub 400, based on the grading for such transactions, and so forth) in order to optimally monitor resources and/or assets under the supervision of resource reallocation hub 400 in real time. In some embodiments, resources and/or assets listed and/or included in the resources and/or assets monitoring database may be of different sizes and levels of granularity. For example, resources and/or assets included in this database may include for example single or multiple core(s) within a CPU unit (e.g. making some of all of the cores within that CPU unit), single or multiple CPU unit(s) combined into one functional entity (for example by the functional resource composer as explained herein), or further combinations of similar assets and/or resources into such functional entities—as well as for example single or multiple memory cells or slots (corresponding to a set of memory addresses) within a single hardware memory unit, multiple such hardware units, multiple units and/or single cells combined into a single functional entity, and so forth. In some embodiments, data and/or information included in the resources and/or assets monitoring database—such as for example those related to resource type, contents, connectivity, and availability—may be based on a resource identification database or table such as for example appropriate inserts in ACPI tables (e.g., that demonstrated in Table 1 herein), which may accordingly be for example queried or searched (e.g., periodically) by embodiments of the invention.

A resource and/or asset monitoring database (such as e.g. demonstrated in Table 2) may thus have a dynamic character and may comprise, include or describe for example a plurality of physical and/or virtual assets and/or resources of different sized and/or scales based on for example the transactions currently being services by resource reallocation hub 400. Resources and/or assets may thus be composed or decomposed (for example by functional resource composer) into a plurality of smaller and/or larger resources, assets, or functional units in order for example to better service asset transactions by resource reallocation hub 400. Embodiments may accordingly update for example the resources and/or assets monitoring database to include newly-created smaller and/or larger resources, which may for example replace database entries describing the parent resource or asset. Embodiments of the invention may accordingly update for example the monitoring database to include such newly-created smaller or larger resources. As a non-limiting example, embodiments of the invention may for example decompose (for example by functional resource composer) a physical memory resource (e.g. of 1 TB) listed in the database (e.g., as a single resource or asset) into for example a set of memory assets (e.g. of 200 GB, 500 GB, and 300 GB) which may subsequently be listed in the database instead of the “parent” resource or asset at a given point in time—for example based on the receiving of a transaction request and/or on parameters or details extracted from such request. Newly created assets (e.g. which were decomposed from a parent resource or asset) may then be graded (e.g. by classification and grading engine) and allocated and/or provisioned (e.g., by harvesting and extraction engine) to service a given transaction as explained herein (e.g. as demonstrated in Procedures I-II).

In order for resource reallocation hub 400 to perform for example resource and/or asset allocation or reallocation procedures, resources and/or assets which may be monitored by embodiments of the invention (e.g., by the resource monitoring engine) and included in the resources and/or assets monitoring database may be associated with connectivity and/or topology data or information, to enable embodiments of the invention to allocate a plurality of resources and/or assets which may in fact be composed into a functional resource (e.g., by functional resource composer; an example for such assets may be for example CPU, memory and storage assets found in the same physical data center, and being physically connected) based on for example details included in a given transaction request, as opposed to resources and/or assets which may not be composed into a functional resource in such manner (for example assets found in different physical data centers and being physically disconnected. Note that the latter example may be relevant, for example, for transactions associated with high performance computing which requires assets to be in close physical proximity to one another; such example, however, should only be considered as non-limiting). Connectivity and/or topology data or information (which may include, inter alia, whether a given resource or asset is local or remote, and so on) may thus be included in a resources and/or assets monitoring database, for example as a text file linked to the latter as demonstrated in Table 2.

As part of migration and/or reallocation processes or procedures which may be carried out by some embodiments of the invention (for example including, but not limited to, Procedures I-II) some embodiments of the invention may, for example update policies and/or predefined conditions and/or criteria or sets of such, according to or based on for example information and settings such as the ones included in policies and/or conditions and/or criteria as described herein.

Some embodiments of the invention may further include for example a resource and/or asset transaction database which may for example take the form illustrated in Table 3 (although this example should be considered as non-limiting).

TABLE 3

| No. | Req_ID | Sender_ID | Req_Contents | Addi_Req_Contents | Policy/Grade |
|---|---|---|---|---|---|
| 1. | [03001] | [04001] | nCores: 4 | Link to a text file/table | A |
| | | | Mem: 40 GB | including a plurality of | |
| | | | Store: 1 TB | additional request | |
| | | | | parameters and details | |
| 2. | [03002] | [04002] | nCores: 16 | As above | B |
| | | | Mem: 160 GB | | |
| | | | Store: 500 GB | | |
| . . . | . . . | . . . | | . . . | |

Details included in Table 3 may for example be extracted from a plurality of transaction requests—for example ones complying to the example format provided herein. As noted regarding Table 2, Table 1 may also be updated periodically to reflect and/or document dynamic resource reallocation and/or transaction migration processes and/or procedures carried out by embodiments of the invention, which may involve different steps or actions by the different modules and/or engines described herein (as a non-limiting example, the policy and/or grading level of a given transaction may be altered by policy and grading engine based on meeting appropriate criteria—such as e.g. if the process associated with a given request takes more than X days to execute then the grade may be lowered by a single level, for example from A to B).

Data structures such as for example Tables 2-3 may be linked or include references to one another in order e.g. to draw inferences on relationship between transactions and resources and/or assets. Embodiments of the invention may thus for example monitor a plurality of data structures (for example including, but not limited to, a resource and/or asset monitoring database and a which may be updated on a regular basis (e.g. periodically), in order to e.g. determine resource utilization levels, and identify idle computing resources. Results and/or outputs of such monitoring may accordingly be recorded and/or documented in corresponding data structures (which may be for example the very data structures being monitored).

Thus, based on data structures such as Tables 2-3, embodiments of the invention may for example monitor and/or check for example: what resources and/or assets are currently used to service a given transaction; what transactions are being serviced using particular resources and/or assets; what resources and/or assets of a particular policy and/or grade level are available to service a request (e.g., of a corresponding grade policy and/or level); what resources and/or assets may be composed into a functional resource; what resources and/or assets may be decomposed into independent sub-parts (for example assets or parts of assets currently not in use which may in principle be broken down to the smallest unit possible, such as a single memory address, to be considered as an independent asset); and the like. Additional uses of such data structures may be included in different embodiments of the invention.

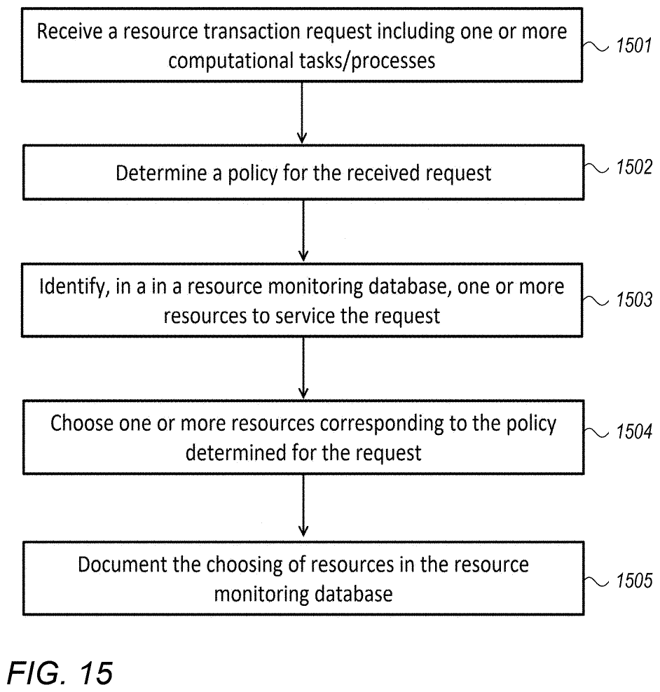

Reference is made to FIG. 15, which is a flowchart of a simple method of multilateral computer resource reallocation, according to some embodiments of the invention.

In Step 1501, a resource transaction request including one or more computational tasks or processes may be received (e.g. via a data network).

In Step 1502, a policy for, or to be applied to, the received request may be determined (for example using a policy engine).

In Step 1503, one or more resources to service the request may be identified in a resource monitoring database (e.g., based on policies determined for the request and/or resources).

In Step 1504, one or more of the identified resources, which may correspond to the policy determined for the request, may be chosen (for example to be further extracted and/or harvested to service the request or one or more tasks included in the request).

In Step 1505, the choosing of resources may be documented in the resource monitoring database.

While certain features of the invention have been illustrated and described herein, many modifications, substitutions, changes, and equivalents may occur to those skilled in the art. It is, therefore, to be understood that the appended claims are intended to cover all such modifications and changes.

Various embodiments have been presented. Each of these embodiments may of course include features from other embodiments presented, and embodiments not specifically described may include various features described herein.

1. A method of multilateral computer resource management and reallocation, the method comprising:
receiving a resource transaction request, the request including one or more computational tasks;
determining a policy for the request;
choosing, in a resource monitoring database, the monitoring database including a plurality of computing resources and a plurality of policies describing one or more of the resources, one or more resources to service the request, wherein one or more of the resources correspond to the policy determined for the request; and
documenting the choosing of one or more of the resources in the monitoring database.

2. The method of claim 1, comprising:
monitoring the resource monitoring database to identify currently available resources;
choosing one or more of the currently available resources according to a first set of predefined conditions;
monitoring a resource transaction database, the transaction database including a plurality of resource transactions, and choosing one or more of the transactions according to a second set of predefined conditions; and
if one or more resources chosen to service the chosen transactions meet a third set of predefined conditions, then reallocating one or more of the currently available resources to service one or more of the chosen transactions.

3. The method of claim 2, wherein the reallocating of one or more of the currently available resource is performed so as to free one or more of the identified resources.

4. The method of claim 2, comprising repeating at least one of: the monitoring of the resource monitoring database, the choosing of the one or more of the currently available resources, the monitoring of the resource transaction database and the choosing of the one or more of the transactions, and the reallocating of the one or more of the currently available resources.

5. The method of claim 1, comprising composing one or more of the resources into one or more larger resources, or decomposing one or more of the resources into one or more smaller resources; and
updating the monitoring database to include one or more of the smaller or larger resources, wherein the monitoring database comprises a plurality of resources of different sizes.

6. The method of claim 2, wherein one or more of the policies and the sets of predefined conditions comprises information or settings for at least one of: frequency of resource monitoring, resource type, resource utilization levels, resource connectivity or topology, grading, urgency level, command queue depths, cache hierarchy utilizations, hit/miss ratios, power consumption, temperature, duty cycle, and historical data of such parameters.

7. The method of claim 1, comprising at least one of: allocating, provisioning, harvesting, and extracting one or more of the chosen resources to perform one or more of the tasks included in the request.

8. The method of claim 1, comprising monitoring one or more of the monitoring database and the transaction database to perform at least one of: determining resource utilization levels, and identifying idle computing resources.

9. The method of claim 6, comprising updating one or more of the policies and the sets of predefined conditions based on one or more of the information or settings.

10. A system comprising:
a memory; and
one or more processors to:
receive a resource transaction request, the request including one or more computational tasks;
determine a policy for the request;
choose, in a resource monitoring database, the monitoring database including a plurality of computing resources and a plurality of policies describing one or more of the resources, one or more resources to service the request, wherein one or more of the resources correspond to the policy determined for the request; and
document the choosing of one or more of the resources in the monitoring database.

11. The system of claim 10, wherein the one or more processors are to monitor the resource monitoring database to identify currently available resources;
choose one or more of the currently available resources according to a first set of predefined conditions;
monitor a resource transaction database, the transaction database including a plurality of resource transactions, and choosing one or more of the transactions according to a second set of predefined conditions; and
if one or more resources chosen to service the chosen transactions meet a third set of predefined conditions, then reallocate one or more of the currently available resources to service one or more of the chosen transactions.

12. The system of claim 11, wherein the reallocating of one or more of the currently available resources is performed so as to free one or more of the identified resources.

13. The system of claim 11, wherein the one or more processors are to repeat at least one of: the monitoring of the resource monitoring database, the choosing of the one or more of the currently available resources, the monitoring of the resource transaction database and the choosing of the one or more of the transactions, and the reallocating of the one or more of the currently available resources.

14. The system of claim 10, wherein the one or more processors are to compose one or more of the resources into one or more larger resources, or decompose one or more of the resources into one or more smaller resources; and
update the monitoring database to include one or more of the smaller or larger resources, wherein the monitoring database comprises a plurality of resources of different sizes.

15. The system of claim 11, wherein one or more of the policies and the sets of predefined conditions comprises information or settings for at least one of: frequency of resource monitoring, resource type, resource utilization levels, resource connectivity or topology, grading, urgency level, command queue depths, cache hierarchy utilizations, hit/miss ratios, power consumption, temperature, duty cycle, and historical data of such parameters.

16. The system of claim 10, wherein one or more of the processors are to perform at least one of: allocate, provision, harvest, and extract one or more of the chosen resources to perform one or more of the tasks included in the request.

17. The system of claim 10, wherein one or more of the processors are to monitor one or more of the monitoring database and the transaction database to perform at least one of: determining resource utilization levels, and identifying idle computing resources.

18. The system of claim 15, wherein one or more of the processors are to update one or more of the plurality of policies and the sets of predefined conditions based on one or more of the information or settings.

19. A method of multilateral computer asset transaction migration, the method comprising:
receiving an asset transaction request, the request including one or more computational processes;
determining a policy for the request;
searching, in an asset monitoring database, the monitoring database including a plurality of computing assets and a plurality of policies describing one or more of the assets, one or more assets to service the request;
selecting one or more of the assets matching the policy determined for the request; and
recording the choosing of one or more of the resources in the monitoring database.

20. The method of claim 19, comprising checking the asset monitoring database to identify idle resources;
selecting one or more of the idle assets according to a first set of predefined criteria;
checking an asset transaction database, the transaction database including a plurality of asset transactions, and selecting one or more of the transactions according to a second set of predefined criteria; and
if one or more resources selected to service the selected transactions meet a third set of predefined criteria, then migrating one or more tasks included in one or more of the selected transactions to one or more of the idle assets.
